(19) United States
(12) Patent Application Publication
(10) Pub. No.: US 2026/0103586 A1
(43) Pub. Date: Apr. 16, 2026

(54) RESISTANCE STABLE POLYMER POSITIVE TEMPERATURE COEFFICIENT (PPTC) MATERIAL

(71) Applicant: Littelfuse, Inc., Rosemont, IL (US)

(72) Inventors: Flory Zhou, Shanghai (CN); Wei Zheng, Shanghai (CN); Qingbei Li, Dongguan (CN); Jianhua Chen, Sunnyvale, CA (US)

(73) Assignee: Littelfuse, Inc., Rosemont, IL (US)

(21) Appl. No.: 19/353,101

(22) Filed: Oct. 8, 2025

(30) Foreign Application Priority Data
Oct. 14, 2024 (CN) 202411429708.9

(51) Int. Cl. C08L 23/06; C08K 3/04; C08K 3/22; C08K 3/26; C08L 27/16; C08L 27/18

(52) U.S. Cl. CPC C08L 23/06; C08K 3/04; C08K 3/22; C08K 3/26; C08L 27/16; C08L 27/18; C08K 2201/001

(57) ABSTRACT

A resistance stable polymer positive temperature coefficient (PPTC) material is provided that can include a polymer matrix, a plurality of filler components disposed in the polymer matrix, and a plurality of carbon black particles bonded around each of the plurality of filler components to increase dispersion of the plurality of carbon black particles in the polymer matrix, thereby increasing a conductive volume of the polymer matrix and reducing a resistance variance in the polymer matrix.

### CROSS REFERENCE TO RELATED APPLICATIONS

This application claims the benefit of priority to, Chinese Patent Application No. 202411429708.9, filed Oct. 14, 2024, entitled “RESISTANCE STABLE POLYMER POSITIVE TEMPERATURE COEFFICIENT (PPTC) MATERIAL,” which application is incorporated herein by reference in its entirety.

### FIELD

The present disclosure generally relates to polymer positive temperature coefficient (PPTC) materials. More particularly, the present disclosure relates to a resistance stable PPTC material.

### BACKGROUND

Positive temperature coefficient (PTC) devices are often used as overcurrent protection devices, over-temperature protection devices, current sensors, temperature sensors, and the like. Furthermore, polymer positive temperature coefficient (PPTC) materials in PTC devices are often arranged as a polymer matrix containing conductive elements, such as carbon black, dispersed within the polymer matrix. The conductive elements generally occupy a sufficient volume fraction of the PPTC material so as to form continuous electrically conductive pathways that impart a relatively lower resistance than non-conductive pathways.

At a given temperature, often referred to as a trip temperature, expansion of the polymer matrix is sufficient to disrupt the continuous electrically conductive pathways so that resistance of the PPTC material may abruptly increase by tenfold, one hundred fold, one thousand fold, etc. Moreover, even below the trip temperature, a resistance change may take place when an environmental temperature change occurs. These resistance changes occur due to thermal expansion or contraction of the polymer matrix impacting electrical connections in the conductive elements dispersed within the polymer matrix. Moreover, these resistance changes as well as resistance distribution may be especially pronounced and/or grow wider with increased resistivity, which can impact yields in PPTC materials with high resistivity, for example, 10-10,000,000 Ohm-cm, and low conductive element content. As such, resistance stability can be negatively impacted, and temperature ranges in which the PPTC materials can be used might be constrained.

In view of the above, there is a continuing, ongoing need for improved materials and devices.

### BRIEF SUMMARY

In some embodiments, a polymer positive temperature coefficient (PPTC) material can include a polymer matrix, a plurality of filler components disposed in the polymer matrix, and a plurality of carbon black particles bonded around each of the plurality of filler components to increase dispersion of the plurality of carbon black particles in the polymer matrix, thereby increasing a conductive volume of the polymer matrix and reducing a resistance variance in the polymer matrix.

In some embodiments, a resistivity of the polymer matrix can be 10-10,000,000 Ohm-cm.

In some embodiments, the plurality of filler components can include an inorganic filler, a metal oxide, a hydroxide, a carbonate, a hydrate, talc, mica, CaCO₃, Mg(OH)₂, or ZnO.

In some embodiments, a volume percentage of the plurality of filler components in the polymer matrix can be 1-50%.

In some embodiments, the volume percentage of the plurality of filler components in the polymer matrix can be 5-40%.

In some embodiments, the plurality of carbon black particles can be chemically bonded to each of the plurality of filler components.

In some embodiments, each of the plurality of filler components can have a first respective chemical group on a respective surface thereof for bonding to a second respective chemical group of each of the plurality of carbon black particles.

In some embodiments, the first respective chemical group on the respective surface of each of the plurality of filler components can include MO, MOH, or MCO₃, where M can include any metal element, and the second respective chemical group of each of the plurality of carbon black particles can include COOH, OH, or CO.

In some embodiments, a resistance coefficient of variation (COV) of the polymer matrix can decrease to 10-60% with inclusion of the plurality of filler components therein.

In some embodiments, the plurality of carbon black particles can be dispersed uniformly on a surface of each of the plurality of filler components.

In some embodiments, the plurality of carbon black particles can comprise an average particle size of 10-100 nm, and the plurality of filler components can comprise an average particle size of 100-100,000 nm.

In some embodiments, a method of preparing a polymer positive temperature coefficient (PPTC) material can include providing a polymer matrix with a resistivity of 10-10,000,000 Ohm-cm, disposing carbon black particles and filler components in the polymer matrix, and bonding a respective plurality of the carbon black particles around each of the filler components to increase dispersion of the carbon black particles in the polymer matrix, thereby increasing a conductive volume of the polymer matrix and reducing a resistance variance of the polymer matrix.

In some embodiments, a volume percentage of the filler components in the polymer matrix can be 1-50%.

In some embodiments, the method can include chemically bonding the respective plurality of the carbon black particles to each of the filler components.

In some embodiments, each of the filler components can have a first respective chemical group on a respective surface thereof for bonding to a second respective chemical group of each of the respective plurality of the carbon black particles.

In some embodiments, the first respective chemical group on the respective surface of each of the filler components can include MO, MOH, or MCO₃, where M can include any metal element, and the second respective chemical group of each of the respective plurality of the carbon black particles can include COOH, OH, or CO.

In some embodiments, the method can include decreasing a resistance coefficient of variation (COV) of the polymer matrix to 10-60% with inclusion of the filler components therein.

In some embodiments, the method can include dispersing the respective plurality of the carbon black particles uniformly on a surface of each of the filler components.

In some embodiments, the carbon black particles can comprise an average particle size of 10-100 nm, and the filler components can comprise an average particle size of 100-100,000 nm.

In some embodiments, a polymer matrix can include a plurality of filler components and a plurality of carbon black particles bonded around each of the plurality of filler components to increase dispersion of the plurality of carbon black particles in the polymer matrix, thereby increasing a conductive volume of the polymer matrix and reducing a resistance variance in the polymer matrix.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a view of a PPTC material in accordance with disclosed embodiments.

FIG. 1B is a view of a carbon black particle chain in a PPTC material in accordance with disclosed embodiments.

FIG. 1C is a view of a carbon black particle in a PPTC material in accordance with disclosed embodiments.

FIG. 2 is a view of a cross-section of a PPTC material in accordance with disclosed embodiments.

FIG. 3 is a view of a cross-section of a PPTC material in accordance with disclosed embodiments.

FIG. 4A is a view of a filler component in accordance with disclosed embodiments.

FIG. 4B is a view of a filler component bonded to a plurality of carbon black particles in accordance with disclosed embodiments.

FIG. 5 is a graph depicting a resistance coefficient of variation (COV) vs. resistivity in accordance with disclosed embodiments.

FIG. 6 is a graph depicting a resistance COV vs. percentage volume of filler components in accordance with disclosed embodiments.

FIG. 7 is a flow chart depicting a method in accordance with disclosed embodiments.

### DETAILED DESCRIPTION

Exemplary embodiments of a resistance stable polymer positive temperature coefficient (PPTC) material in accordance with the present disclosure will now be described more fully hereinafter with reference made to the accompanying drawings. The resistance stable PPTC material may, however, be embodied in many different forms and should not be construed as being limited to the embodiments set forth herein. Rather, these embodiments are provided so that this disclosure will convey certain exemplary aspects of the resistance stable PPTC material to those skilled in the art.

In accordance with disclosed embodiments, the resistance stable PPTC material (the “PPTC material”) can be used in connection with a PPTC device configured to operate with a stable resistance in a normal operating temperature range below a trip temperature. In this context, “stable” refers to comparison to another device without the PPTC material disclosed herein and achieving a relatively lesser resistance change in the PPTC material when cycled up and down through the normal operating temperature range, relatively lesser overall change in resistance when a temperature is increased from room temperature to the trip temperature, relatively lower distribution of resistance values, or any combination thereof.

The PPTC material disclosed herein can combine a high loading filler with a conductive element, such as carbon black, to improve resistance distribution of the PPTC material, thereby making the PPTC material resistance stable. In some embodiments, the high loading filler can include a commercial, inorganic filler, such as a metal oxide, a hydroxide, a carbonate, a hydrate, talc, mica, CaCO₃, Mg(OH)₂, or ZnO. Furthermore, in some embodiments, the PPTC material can be loaded with such filler so that filler components occupy 1-50% of a volume of the PPTC material, and in some embodiments, 5-40% of the volume of the PPTC material.

In accordance with disclosed embodiments, the carbon black can be strongly bonded to the filler components. For example, in some embodiments, each of the filler components can include a respective chemical group on a respective surface thereof that can form a strong chemical bond with a chemical group of the carbon black. When the carbon black is bonded to the filler components in this manner, dispersion of the carbon black in the PPTC material can be improved when compared to dispersion of carbon black in PPTC materials without such filler components and a conductive volume of the PPTC material can be increased when compared to PPTC materials without such filler components, thereby reducing a resistance variation of the PPTC material.

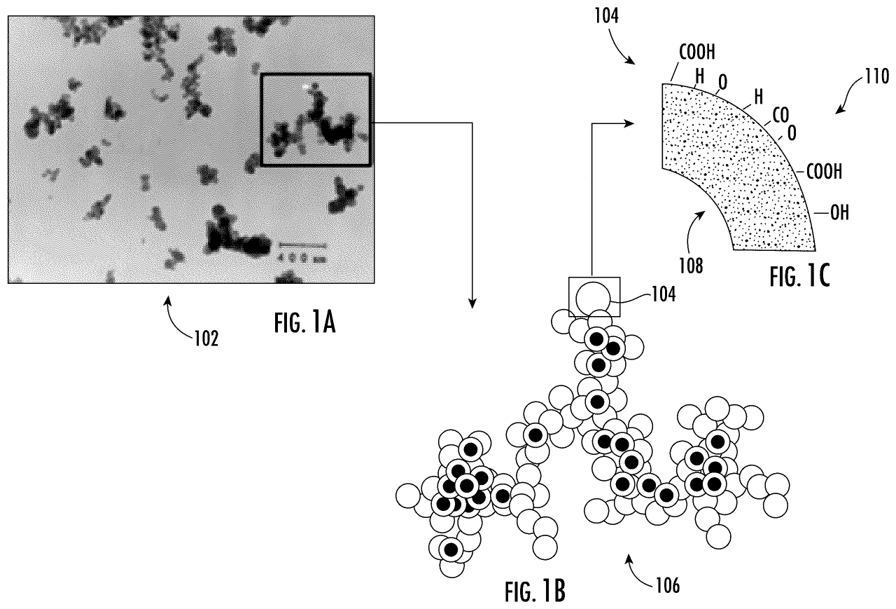

FIG. 1A, FIG. 1B, and FIG. 1C are different views of a PPTC material in accordance with disclosed embodiments. As seen, conductive elements, for example, carbon black particles 104, can be dispersed in a polymer matrix 102.

The PPTC material disclosed herein can have different applications and/or different melting points. In this regard, the polymer matrix 102 can include polyethylene (PE), ethylene tetrafluoroethylene (ETFE), polyvinylidene difluoride (PVDF), and/or any of these polymers and their copolymers, such as, for example, ethylene-vinyl acetate, ethylene and an acrylic acid copolymer, an ethylene butyl acrylate copolymer, a polyolefin elastomer, polyethylene oxide, a fluororesin, polyvinyl fluoride, polydivinyl fluoride, polytetrafluoroethylene, an ethylene-tetrafluoroethylene copolymer, polycaprolactone, polyethylene glycol, polytetrahydrofuran, polyurethane, a polyamide, a copolymer of polyamide, a diene elastomer, a copolymer of diene elastomer, or a combination thereof. In some embodiments, the polymer matrix 102 can also include an antioxidant, a dispersion agent, a cross-linker, an arc suppressant, a flame retardant agent, a coupling agent, or combination thereof.

The carbon black particles 104 can be isolated as single particles, but agglomerate in groups that include a plurality of carbon black particles 104 ranging from just a few to tens, hundreds, or thousands. For example, as seen in FIG. 1A and FIG. 1B, in particular, when dispersed in the polymer matrix 102, the carbon black particles can agglomerate in carbon black particle chains 106 or chain-like configurations to form networks of continuously electrically conductive paths that span macroscopic distances, such as millimeters or more.

In some embodiments, the carbon black particles 104 may undergo one or more surface treatments. As seen in FIG. 1C, in particular, an interior 108 of a carbon black particle 104 can be predominantly carbon. However, a treated surface 110 of the carbon black particle 104 can have different chemical and physical characteristics. For example, the treated surface 110 can include a number polar species or polar groups that can lead to the carbon black particle 104 being dispersed within the polymer matrix 102 and bonding to each other and to other components in the polymer matrix 102 as described herein. In some embodiments, the treated surface 110 can include a high-temperature oxidized surface. Additionally or alternatively, in some embodiments, the treated surface 110 can include a grafted surface and include heterogeneous (non-carbon) species bonded to the interior 108. Additionally or alternatively, in some embodiments, the treated surface 110 can be treated with a coupling agent.

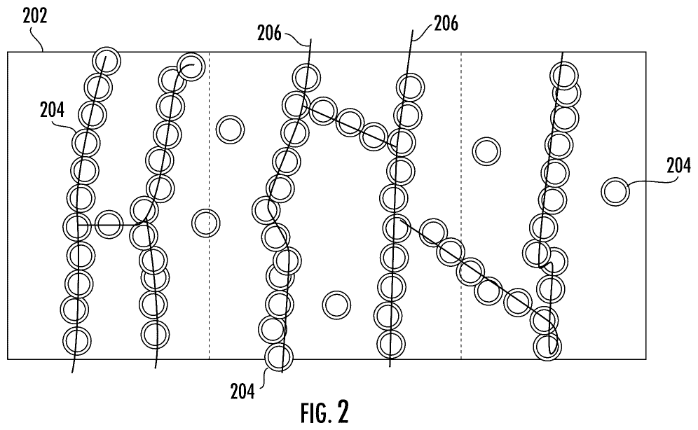

FIG. 2 is a view of a cross-section of a PPTC material in accordance with disclosed embodiments. As seen, the PPTC material can include a polymer matrix 202 and a plurality of carbon black particles 204 disposed in the polymer matrix 202. FIG. 2 is illustrated with lines to visualize electrically conductive pathways 206 formed through chains of the plurality of carbon black particles 204. In FIG. 2, the polymer matrix 202 can include approximately 85-90% polymer and approximately 10-15% carbon black particles 204.

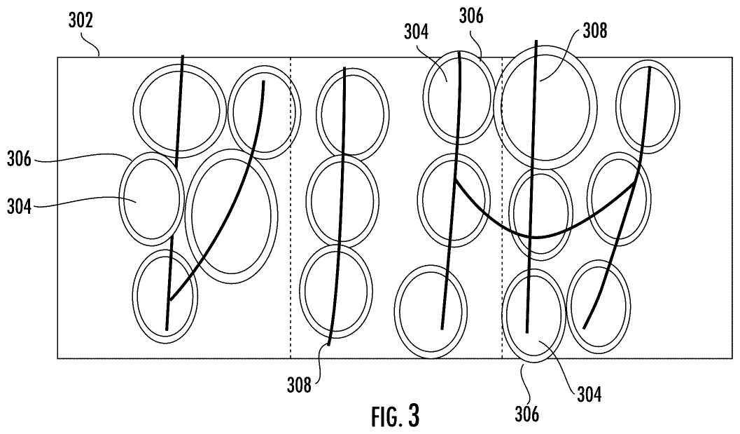

FIG. 3 is a view of a cross-section of a PPTC material in accordance with disclosed embodiments. As seen, the PPTC material can include a polymer matrix 302, a plurality of filler components 304 disposed in the polymer matrix 302, and a plurality of carbon black particles 306 bonded around each of the plurality of filler components 304. FIG. 3 is illustrated with lines to visualize electrically conductive pathways 308 formed through chains of the plurality of filler components 304 and the plurality of carbon black particles 306 bonded thereto. In FIG. 3, the polymer matrix 302 can include approximately 55-70% polymer and approximately 30-45% filler components 304 and carbon black particles 306.

In some embodiments, the plurality of filler components 304 can include conductive particles or materials, semi-conductive particles or materials, insulating particles or materials, or a combination thereof. In some embodiments, the plurality of filler components 304 can include an inorganic filler, a metal oxide, a hydroxide, a carbonate, a hydrate, talc, mica, CaCO₃, Mg(OH)₂, or ZnO.

The configuration of the PPTC material shown and described in connection with FIG. 3 can increase dispersion of the plurality of carbon black particles 306 in the polymer matrix 302 and increase a conductive volume of the polymer matrix 302, thereby reducing a resistance variance in the polymer matrix 302 when compared to the PPTC material of FIG. 2. In particular, because the plurality of carbon black particles 306 bond around each of the plurality of filler components 304, the plurality of carbon black particles 306 in the polymer matrix will be more dispersed and the conductive volume of the polymer matrix 302 will be higher, both of which can reduce the resistance variance in the polymer matrix 302.

More particularly, because dispersion is better in the PPTC material of FIG. 3 as compared to the PPTC material of FIG. 2, the conductive volume of the polymer matrix 302 is higher than a conductive volume of the polymer matrix 202 and a greater number of electrically conductive pathways 308 can be formed in the polymer matrix 302 as compared to the polymer matrix 202. Because of a lower conductive volume in the PPTC material of FIG. 2, any small fluctuation in a number of the carbon black particles 204 and/or conductive connections therebetween can cause a large variation in resistance. In comparison, because of a higher conductive volume in the PPTC material of FIG. 3, a small variation in a number of the carbon black particles 306, conductive connections therebetween, and/or conductive connections between the carbon black particles 306 and the filler components 304 will not substantially change resistance.

Furthermore, when cycled between lower and higher temperatures, the electrically conductive pathways 308 can be better retained than the electrically conductive pathways 206, which are more disrupted as the polymer matrix 202 expands and contacts. Such preservation of the electrically conductive pathways 308 can further stabilizing resistance changes and resistance distribution.

The above-described stability can be especially useful for PPTC materials with high resistivity. Accordingly, in some embodiments, a resistivity of the polymer matrix 302 can be 10-10,000,000 Ohm-cm.

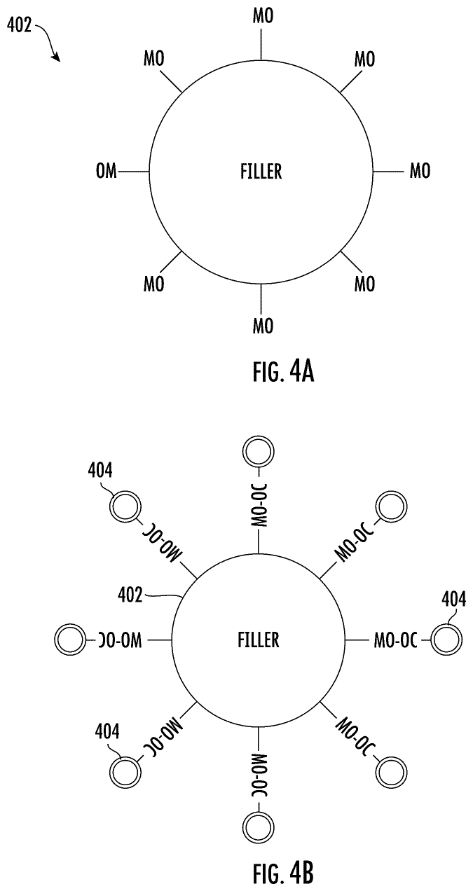

As explained above, carbon black particles can bond to filler components in a polymer matrix of a PPTC material. In this regard, FIG. 4A is a view of a filler component 402 in accordance with disclosed embodiments, and FIG. 4B is a view of the filler component 402 bonded to a plurality of carbon black particles 404 in accordance with disclosed embodiments. As seen, the plurality of carbon black particles 404 can be chemically bonded to the filler component 402. In particular, the filler component 402 can have a first chemical group on a surface thereof for bonding to a second respective chemical group of each of the plurality of carbon black particles 404. In some embodiments, the first chemical group can include MO, MOH, or MCO₃, such that M can include any metal element. Additionally or alternatively, in some embodiments, the second respective chemical group of each of the plurality of carbon black particles 404 can include COOH, OH, or CO.

In some embodiments, the first chemical group can be distributed around a surface of the filler component 402. As such, in some embodiments, the plurality of carbon black particles 404 can be dispersed uniformly on the surface of the filler component 402.

In some embodiments, the plurality of carbon black particles 404 can have an average particle size of 10-100 nm. However, the filler component 402 can have a particle size of 100-100,000 nm. Thus, in some embodiments, the filler component 402 can be approximately 100 times larger than each of the plurality of carbon black particles 404 bonded thereto.

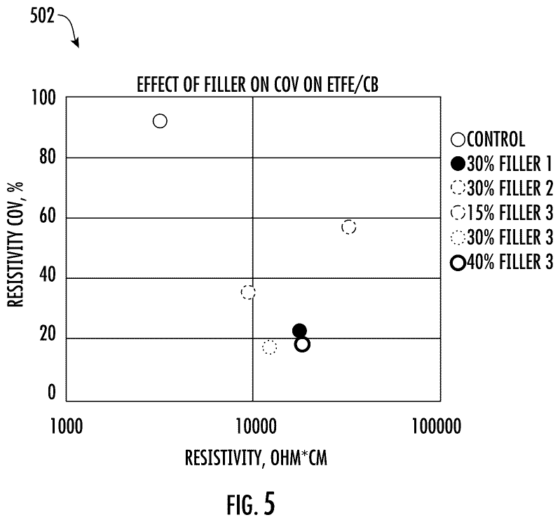

FIG. 5 is a graph 502 depicting a resistance coefficient of variation (COV) vs. resistivity of a PPTC material for a control sample, a first filler component sample, a second filler component sample, and a third filler component sample at three different volume percentages. In some embodiments, the control sample can include the PPTC material of FIG. 2, and in some embodiments, the first filler component sample, the second filler component sample, and/or the third filler component sample can include the PPTC material of FIG. 3. As seen, the resistance COV can decrease from almost 100% to 10-60% with inclusion of any of the first filler component sample, the second filler component sample, and/or third filler component sample.

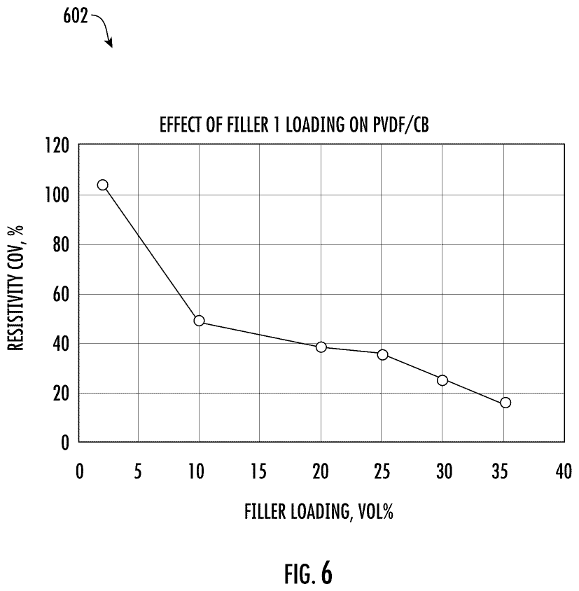

FIG. 6 is a graph 602 depicting the resistance COV vs. a percentage volume of filler components. In some embodiments, different points on the graph 602 can represent one or more of the filler component samples of FIG. 5 at different volume percentages. As seen, the resistivity COV can drop as a percentage of a conductive volume in the polymer matrix, including the filler components, increases. In particular, in some embodiments, when the volume percentage of the filler components is 1-50%, the resistance COV can be 10-60%. In some embodiments, when the volume percentage of the filler components is 5-40%, the resistivity COV can be 10-60%

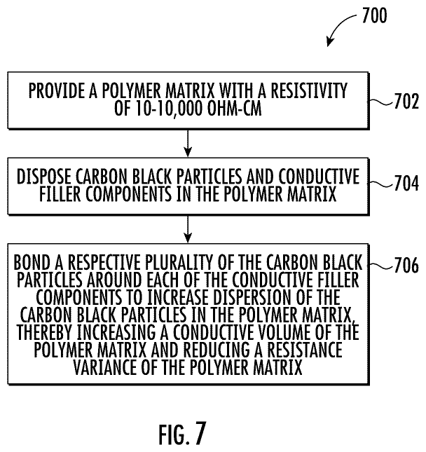

FIG. 7 is a flow chart depicting a method 700 in accordance with disclosed embodiments. As seen, the method 700 can include providing a polymer matrix with a resistivity of 10-10,000,000 Ohm-cm as in 702 and disposing carbon black particles and filler components in the polymer matrix as in 704. In some embodiments, the carbon black particles can comprise an average particle size of 10-100 nm, and in some embodiments, the filler components can comprise an average particle size of 100-100,000 nm. Furthermore, in some embodiments, a volume percentage of the filler components in the polymer matrix can be 1-50%, and in some embodiments, the volume percentage of the filler components in the polymer matrix can be 5-40%.

The method 700 can also include bonding a respective plurality of the carbon black particles around each of the filler components as in 706. Such bonding can increase dispersion of the carbon black particles in the polymer matrix, thereby increasing a conductive volume of the polymer matrix and reducing a resistance variance of the polymer matrix. In some embodiments, inclusion of the filler components in the polymer matrix can decrease a resistance COV of the polymer matrix to 10-60%.

In some embodiments, the respective plurality of the carbon black particles can be dispersed uniformly on a surface of each of the filler components when bonded thereto as in 706. Furthermore, in some embodiments, such bonding can include chemically bonding the respective plurality of the carbon black particles to each of the filler components. For example, in some embodiments, each of the filler components can have a first respective chemical group on a respective surface thereof for bonding to a second respective chemical group of each of the respective plurality of the carbon black particles. In some embodiments, the first respective chemical group on the respective surface of each of the filler components can include MO, MOH, or MCO₃, wherein M can include any metal element, and the second respective chemical group of each of the respective plurality of the carbon black particles can include COOH, OH, or CO.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A polymer positive temperature coefficient (PPTC) material comprising:
a polymer matrix;
a plurality of filler components disposed in the polymer matrix; and
a plurality of carbon black particles bonded around each of the plurality of filler components to increase dispersion of the plurality of carbon black particles in the polymer matrix, thereby increasing a conductive volume of the polymer matrix and reducing a resistance variance in the polymer matrix.

2. The PPTC material of claim 1, wherein a resistivity of the polymer matrix is 10-10,000,000 Ohm-cm.

3. The PPTC material of claim 1, wherein the plurality of filler components includes an inorganic filler, a metal oxide, a hydroxide, a carbonate, a hydrate, talc, mica, CaCO₃, Mg(OH)₂, or ZnO.

4. The PPTC material of claim 1, wherein a volume percentage of the plurality of filler components in the polymer matrix is 1-50%.

5. The PPTC material of claim 4, wherein the volume percentage of the plurality of filler components in the polymer matrix is 5-40%.

6. The PPTC material of claim 1, wherein the plurality of carbon black particles is chemically bonded to each of the plurality of filler components.

7. The PPTC material of claim 6, wherein each of the plurality of filler components has a first respective chemical group on a respective surface thereof for bonding to a second respective chemical group of each of the plurality of carbon black particles.

8. The PPTC material of claim 7, wherein the first respective chemical group on the respective surface of each of the plurality of filler components includes MO, MOH, or MCO₃, wherein M includes any metal element, and wherein the second respective chemical group of each of the plurality of carbon black particles includes COOH, OH, or CO.

9. The PPTC material of claim 1, wherein a resistance coefficient of variation (COV) of the polymer matrix decreases to 10-60% with inclusion of the plurality of filler components therein.

10. The PPTC material of claim 1, wherein the plurality of carbon black particles are dispersed uniformly on a surface of each of the plurality of filler components.

11. The PPTC material of claim 1, wherein the plurality of carbon black particles comprise an average particle size of 10-100 nm, and wherein the plurality of filler components comprise an average particle size of 100-100,000 nm.

12. A method of preparing a polymer positive temperature coefficient (PPTC) material comprising:
providing a polymer matrix with a resistivity of 10-10,000,000 Ohm-cm;
disposing carbon black particles and filler components in the polymer matrix; and
bonding a respective plurality of the carbon black particles around each of the filler components to increase dispersion of the carbon black particles in the polymer matrix, thereby increasing a conductive volume of the polymer matrix and reducing a resistance variance of the polymer matrix.

13. The method of claim 12, wherein a volume percentage of the filler components in the polymer matrix is 1-50%.

14. The method of claim 12 further comprising:
chemically bonding the respective plurality of the carbon black particles to each of the filler components.

15. The method of claim 14, wherein each of the filler components has a first respective chemical group on a respective surface thereof for bonding to a second respective chemical group of each of the respective plurality of the carbon black particles.

16. The method of claim 15, wherein the first respective chemical group on the respective surface of each of the filler components includes MO, MOH, or MCO₃, wherein M includes any metal element, and wherein the second respective chemical group of each of the respective plurality of the carbon black particles includes COOH, OH, or CO.

17. The method of claim 12 further comprising:
decreasing a resistance coefficient of variation (COV) of the polymer matrix to 10-60% with inclusion of the filler components therein.

18. The method of claim 12 further comprising:
dispersing the respective plurality of the carbon black particles uniformly on a surface of each of the filler components.

19. The method of claim 12, wherein the carbon black particles comprise an average particle size of 10-100 nm, and wherein the filler components comprise an average particle size of 100-100,000 nm.

20. A polymer matrix comprising:
a plurality of filler components; and
a plurality of carbon black particles bonded around each of the plurality of filler components to increase dispersion of the plurality of carbon black particles in the polymer matrix, thereby increasing a conductive volume of the polymer matrix and reducing a resistance variance in the polymer matrix.
